(19) United States
(12) Patent Application Publication
(10) Pub. No.: US 2026/0186759 A1
(43) Pub. Date: Jul. 2, 2026

(54) MMBI OS DEPLOYMENT SYSTEM

(71) Applicant: Dell Products L.P., Round Rock, TX (US)

(72) Inventors: Nagaraj Annenavar, Bengaluru (IN); Raveendra Reddy Padala, Bangalore (IN); Jitendra Kumar, Bengaluru (IN)

(21) Appl. No.: 19/002,920

(22) Filed: Dec. 27, 2024

(51) Int. Cl. G06F 8/61

(52) U.S. Cl. CPC G06F 8/63

(57) ABSTRACT

An MMBI operating system deployment system includes a chassis housing a BMC device that includes a BMC memory subsystem and that is coupled to a host processing subsystem. The host processing subsystem provides a BIOS subsystem that, during initialization operations, instructs the BMC device to retrieve operating system installer information, and subsequently copies portions of the operating system installer information from the BMC memory subsystem to a host memory subsystem using an MMBI. The host processing subsystem then uses the operating system installer information in the host memory subsystem to provide an operating system installer subsystem that, during the initialization operations, instructs the BMC device to retrieve operating system image information, subsequently copies portions of the operating system image information from the BMC memory subsystem to the host memory subsystem using the MMBI, and installs an operating system using the operating system image information in the host memory subsystem.

### BACKGROUND

The present disclosure relates generally to information handling systems, and more particularly to deploying operating systems on information handling systems using a Memory-Mapped Baseboard Management Controller (BMC) Interface (MMBI).

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, are sometimes provided in environments with relatively low or limited management network connectivity. For example, computing devices utilized at the “edge” of a network and/or in Telecommunications (“Telco”) environments often have their networking bandwidth primarily allocated for their data plane communications, thus limiting the amount of their networking bandwidth available for their management plane communications, which can raise issues. One such issue can arise when operating systems are deployed on such computing devices via the management plane and using a management network, as conventional operating system deployment is performed using virtual Universal Serial Bus (USB) techniques implemented via a network-accessible storage system accessed via the management network.

To provide a specific example, a Baseboard Management Controller (BMC) in the computing device may present a virtual USB device (e.g., a virtual USB flash memory device) that stores operating system deployment information to a host engine in the computing device, with the physical storage of that virtual USB device provided by the network-accessible storage system that is accessible via the management network. As will be appreciated by one of skill in the art, the host engine must then transmit a USB request for the operating system deployment information to the virtual USB device (which appears to the host engine as a local USB device) such that it is received by the BMC, with the BMC then converting that USB request to a network request and providing that network request over the management network to retrieve that operating system deployment information from the network-accessible storage system, and providing that operating system deployment information back to the host engine as a USB response.

However, the low/limited management network connectivity between the BMC and the network-accessible storage system can cause issues with operating system deployment, particularly when the networking bandwidth allocated to the management network fluctuates, as the USB specification requires USB communications like those discussed above to complete within 10 seconds before those USB communication “time out” and cause the host engine to “disconnect” and reset the virtual USB device, resulting in an operating system deployment failure. This issue is particularly troublesome in low management networking connectivity and/or high networking bandwidth fluctuation environments, as the host engine may repeatedly “disconnect”/reset the virtual USB device upon each time out, resulting in user dissatisfaction, customer support resource expenditures, and/or other issues known in the art.

Accordingly, it would be desirable to provide an operating system deployment system that addresses the issues discussed above.

### SUMMARY

According to one embodiment, an Information Handling System (IHS) includes a host processing system; and a host memory system that is coupled to the host processing system and that includes instructions that, when executed by the host processing system, cause the host processing system to provide a host processing engine that is configured to provide a Basic Input/Output System (BIOS) engine that is configured, during initialization operations, to: instruct a Baseboard Management Controller (BMC) device that is coupled to the host processing system to retrieve operating system installer information; and copy, to a host memory subsystem using a Memory Mapped BMC Interface (MMBI) subsequent to instructing the BMC device to retrieve the operating system installer information, a plurality of portions of the operating system installer information from a BMC memory subsystem included in the BMC device, wherein the host engine is configured to use the operating system installer information that was copied to the host memory subsystem to provide an operating system installer engine that is configured, during the initialization operations, to: instruct the BMC device to retrieve operating system image information; copy, to the host memory subsystem using the MMBI subsequent to instructing the BMC device to retrieve the operating system image information, a plurality of portions of the operating system image information from the BMC memory subsystem; and install, using the operating system image information that was copied to the host memory subsystem, an operating system.

### BRIEF DESCRIPTION OF THE DRAWINGS

FIG. 1 is a schematic view illustrating an embodiment of an Information Handling System (IHS).

FIG. 2 is a schematic view illustrating an embodiment of a networked system that includes the MMBI operating system deployment system of the present disclosure.

FIG. 3A is a flow chart illustrating an embodiment of a portion of a method for deploying an operating system on a computing device using an MMBI.

FIG. 3B is a flow chart illustrating an embodiment of a portion of a method for deploying an operating system on a computing device using an MMBI.

FIG. 4 is a schematic view illustrating an embodiment of the networked system of FIG. 2 operating during the method of FIG. 3.

FIG. 5 is a schematic view illustrating an embodiment of the networked system of FIG. 2 operating during the method of FIG. 3.

FIG. 6 is a schematic view illustrating an embodiment of the networked system of FIG. 2 operating during the method of FIG. 3.

FIG. 7 is a schematic view illustrating an embodiment of the networked system of FIG. 2 operating during the method of FIG. 3.

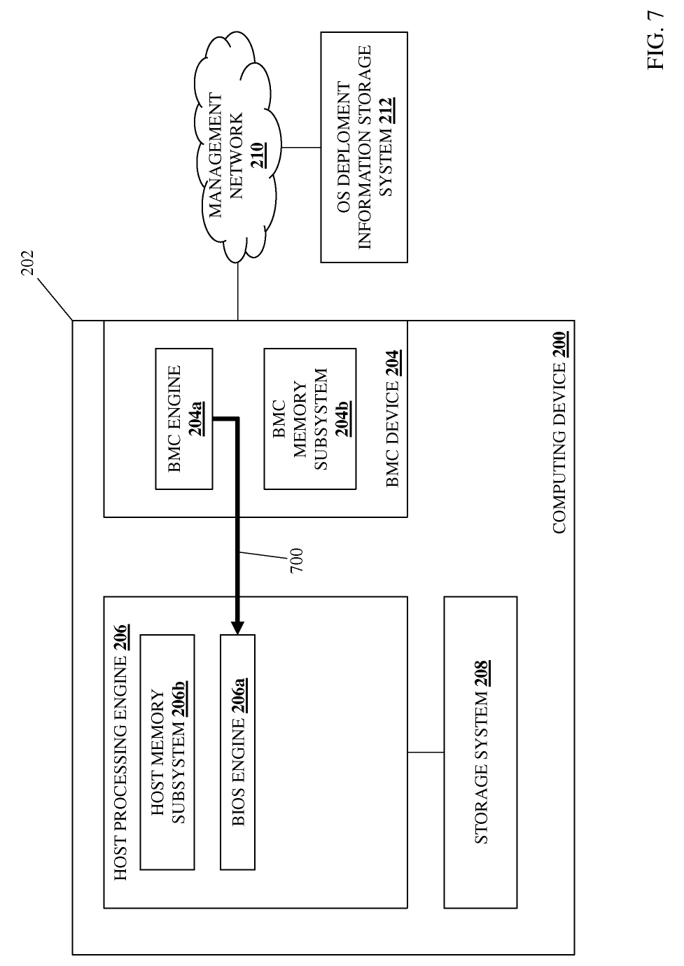

FIG. 8 is a schematic view illustrating an embodiment of the networked system of FIG. 2 operating during the method of FIG. 3.

FIG. 9 is a schematic view illustrating an embodiment of the networked system of FIG. 2 operating during the method of FIG. 3.

FIG. 10 is a schematic view illustrating an embodiment of the networked system of FIG. 2 operating during the method of FIG. 3.

FIG. 11 is a schematic view illustrating an embodiment of the networked system of FIG. 2 operating during the method of FIG. 3.

FIG. 12 is a schematic view illustrating an embodiment of the networked system of FIG. 2 operating during the method of FIG. 3.

FIG. 13 is a schematic view illustrating an embodiment of the networked system of FIG. 2 operating during the method of FIG. 3.

FIG. 14 is a schematic view illustrating an embodiment of the networked system of FIG. 2 operating during the method of FIG. 3.

FIG. 15 is a schematic view illustrating an embodiment of the networked system of FIG. 2 operating during the method of FIG. 3.

FIG. 16 is a schematic view illustrating an embodiment of the networked system of FIG. 2 operating during the method of FIG. 3.

FIG. 17 is a schematic view illustrating an embodiment of the networked system of FIG. 2 operating during the method of FIG. 3.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

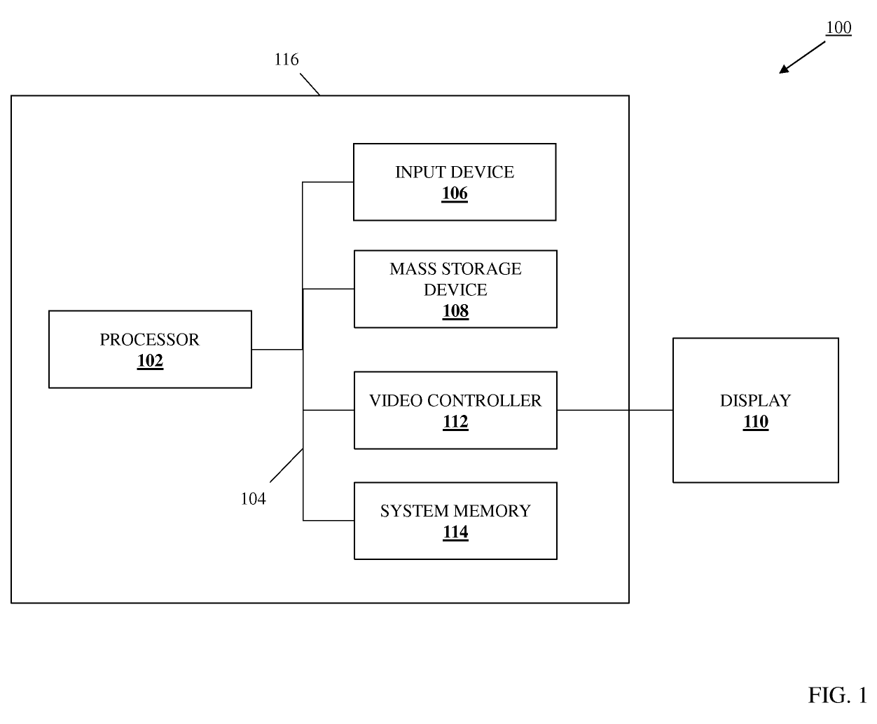

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

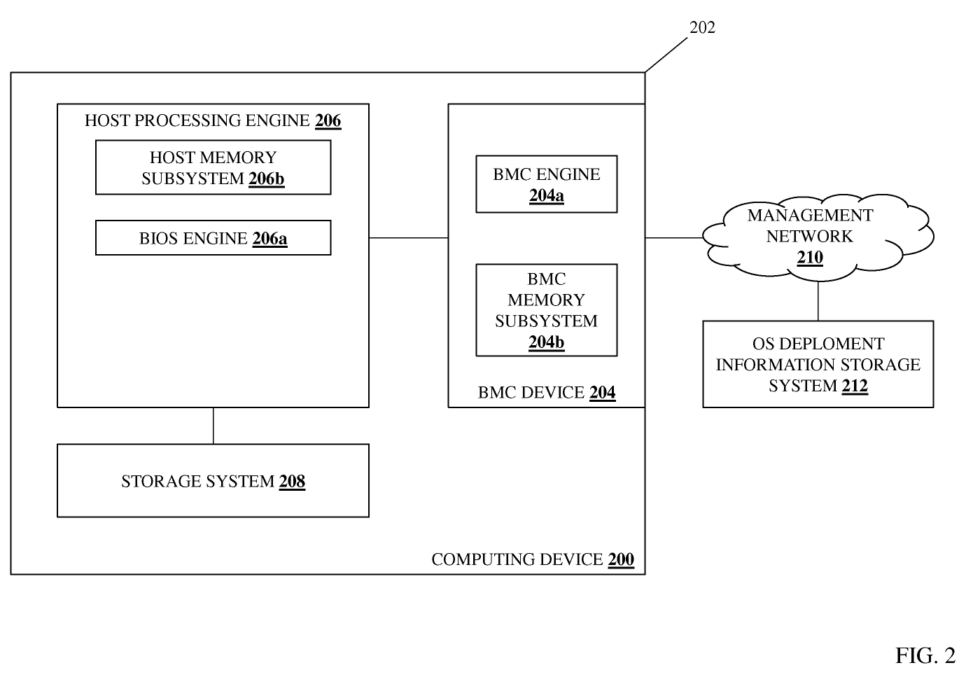

Referring now to FIG. 2, an embodiment of a networked system is illustrated that may include the MMBI operating system deployment system of the present disclosure. In the illustrated embodiment, the networked system includes a computing device 200. In an embodiment, the computing device may be provided by the IHS 100 discussed above with reference to FIG. 1, and/or may include some or all of the components of the IHS 100, and in specific examples may be provided by a server device. However, while illustrated and discussed as being provided by a server device, one of skill in the art in possession of the present disclosure will recognize that computing devices provided in the networked system of the present disclosure may include any computing devices that may be configured to operate similarly as the computing device 200 discussed below.

In the illustrated embodiment, the computing device 200 includes a chassis 202 that houses the components of the computing device 200, only some of which are illustrated and described below. For example, the chassis 202 may house a Baseboard Management Controller (BMC) device 204 that may be provided by an integrated DELL® Remote Access Controller (iDRAC) included in server devices available from DELL® Inc. of Round Rock, Texas, United States; according to the OpenBMC standards promulgated by the LINUX® foundation via the OpenBMC project; and/or using any other BMC devices that would be apparent to one of skill in the art in possession of the present disclosure. As will be appreciated by one of skill in the art in possession of the present disclosure, in addition to the MMBI operating system deployment functionality described below, the BMC device 204 may be configured to perform conventional BMC functionality such as providing an out-of-band management platform for the computing device 200 (using mostly separate resources from the computing device 200) via a browser-based interface or Command Line Interface (CLI) that enables management and monitoring of hardware in the computing device 200.

The BMC device 204 may include a BMC processing system (not illustrated, but which may be similar to the processor 102 discussed above with reference to FIG. 1) and a BMC memory system (not illustrated, but which may be similar to the memory 114 discussed above with reference to FIG. 1) that is coupled to the BMC processing system and that includes instructions that, when executed by the BMC processing system, cause the BMC processing system to provide a BMC engine 204a that is configured to perform the functionality of the BMC engines, BMC subsystems, and/or computing devices discussed below.

As discussed in further detail below, the BMC device 204 may include a BMC memory subsystem 204b. In an embodiment, the BMC memory subsystem 204b may be provided using a portion of the BMC memory system discussed above, and may be configured for use by the BMC engine 204a with the Memory Mapped BMC Interface (MMBI) described below using any of a variety of MMBI memory subsystem configuration techniques that would be apparent to one of skill in the art in possession of the present disclosure. For example, the BMC memory subsystem 204b may be designated as a region of the BMC memory system that is shared between the BMC engine 204a and the host processing engine 206 discussed in further detail below, with that shared memory region mapped into the address space of both the BMC engine 204a and the host processing engine 206 (e.g., providing a PCIe “mailbox” via an internal memory map between the BMC engine 204a and the host processing engine 206 that enables the MMBI payload transmission described below). In a specific example, the BMC memory subsystem 204b may be configured with a storage capacity of 16KB, although other storage capacities for the BMC memory subsystem will fall within the scope of the present disclosure as well. However, while a specific example of a MMBI BMC memory subsystem has been illustrated and described, one of skill in the art in possession of the present disclosure will appreciate how a variety of BMC memory subsystems may be used in the MMBI operating system deployment system of the present disclosure while remaining within its scope as well.

The chassis 202 may also house a host processing system (not illustrated, but which may include the processor 102 discussed above with reference to FIG. 1 such as, for example, a Central Processing Unit (CPU) and/or other host processors known in the art) and a host memory system (not illustrated, but which may include the memory 114 discussed above with reference to FIG. 1 such as, for example, Dynamic Random Access Memory (DRAM) and/or other host memory known in the art) that is coupled to the host processing system and that includes instructions that, when executed by the host processing system, cause the host processing system to provide a host processing engine 206 that is configured to perform the functionality of the host processing engines and/or computing devices discussed below. As illustrated, the host processing engine 206 is coupled to the BMC device 204 (e.g., via a coupling between the host processing system and the BMC device 204) by one or more connections (e.g., Peripheral Component Interconnect express (PCIe) connection(s)), and as discussed below at least one of those connection(s) is configured to provide an MMBI between the host processing engine 206 and the BMC device 204.

In an embodiment, the host processing engine 206 may be configured to provide a BIOS engine 206a that is configured to perform the functionality of the BIOS engines, BIOS subsystems, and/or computing devices discussed below. For example, the host processing system and host memory system discussed above may include BIOS firmware that provides the BIOS engine 206a that is configured to provide a BIOS that, in addition to the MMBI operating system deployment functionality described in further detail below, may be configured to perform hardware initialization during boot operations (e.g., Power-On STartup (POST)) and/or other initialization operations for the computing device 200, runtime services for operating systems and applications provided on the computing device 200, and/or other conventional BIOS operations known in the art. In a specific example, the BIOS engine 206 may include a BIOS/MMBI driver that configures the BIOS engine 206a to provide the MMBI functionality described below.

As discussed in further detail below, the host processing engine 206 may also include a host memory subsystem 206b. In an embodiment, the host memory subsystem 206b may be provided using a portion of the host memory system discussed above, and may be configured for use by the host processing engine 206 with the MMBI as described below. However, while a specific example of a MMBI host memory subsystem has been illustrated and described, one of skill in the art in possession of the present disclosure will appreciate how a variety of host memory subsystems may be used in the MMBI operating system deployment system of the present disclosure while remaining within its scope as well.

The chassis 202 may also house a storage system 208 (e.g., which may include the storage 108 discussed above with reference to FIG. 1) that is coupled to the host processing engine 206 (e.g., via a coupling between the storage system 208 and the host processing system) and that may include any storage device(s) (e.g., Solid State Drive (SSD) storage device(s)) that one of skill in the art in possession of the present disclosure would recognize as providing storage for operating system information that is used to provide an operating system as described below.

As illustrated, the BMC device 204 in the computing device 200 may be coupled to a management network 210 that may be provided by a Local Area Network (LAN), the Internet, combinations thereof, and/or any other networks that would be apparent to one of skill in the art in possession of the present disclosure. Furthermore, an operating system deployment information storage system 212 may be coupled to the network 210 and may store the operating system installer information (i.e., information for providing an operating system installer as described below), the operating system image information (e.g., an operating system image that may be used to install an operating system), and/or any other operating system deployment information used in the MMBI operating system deployment system described below. In a specific example, the operating system deployment storage system 212 may include a Common Internet File System (CIFS), a Network File System (NFS), and/or other data storage structure that may provide a “network share” including folders and files (e.g., “ISO” files, “IMG” files, etc.) that provide the operating system deployment information described below, although other storage systems using other data storage structures will fall within the scope of the present disclosure as well.

As discussed above, the networking bandwidth of the computing device 200 may be primarily allocated for data plane communications, thus limiting the amount of networking bandwidth available for management plane communications via the management network 210 (e.g., the BMC device 204 may be allocated a networking bandwidth of 8 Kbps – 1 Mbps, and that networking bandwidth may fluctuate as described above). However, while a specific networked system has been illustrated and described, one of skill in the art in possession of the present disclosure will recognize that networked systems (or other device(s) operating according to the teachings of the present disclosure in a manner similar to that described below for the computing device 202 in the networked system) may include a variety of components and/or component configurations for providing conventional networked system/computing device functionality, as well as the MMBI operating system deployment functionality discussed below, while remaining within the scope of the present disclosure as well.

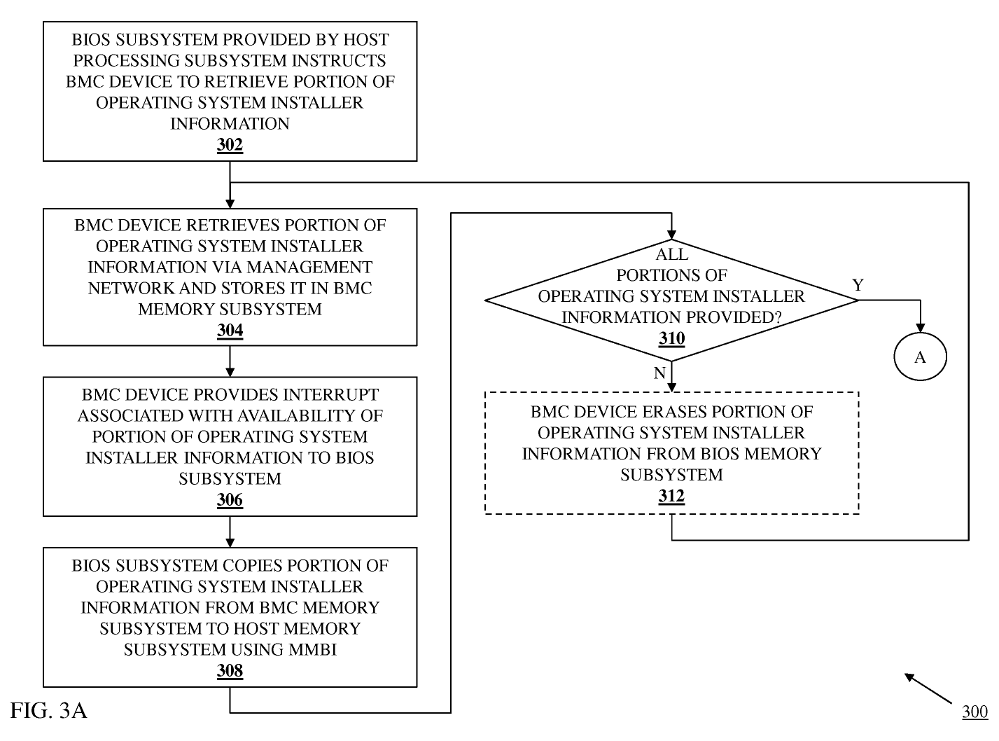

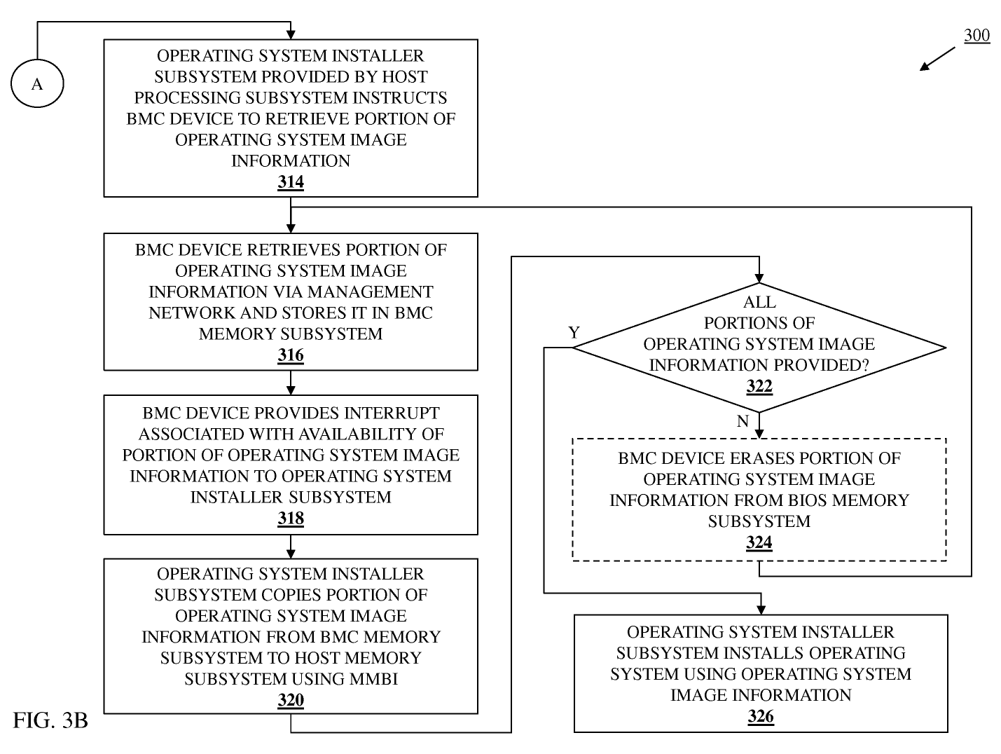

Referring now to FIGS. 3A and 3B, an embodiment of a method 300 for deploying an operating system on a computing device using a Memory Mapped Baseboard Management Controller (BMC) Interface (MMBI) is illustrated. As discussed below, the systems and methods of the present disclosure provide for the deployment of operating system via a host processing subsystem using operating system deployment information retrieved from a BMC device via an MMBI. For example, the MMBI operating system deployment system of the present disclosure may include a chassis housing a BMC device that includes a BMC memory subsystem and that is coupled to a host processing subsystem. The host processing subsystem provides a BIOS subsystem that, during initialization operations, instructs the BMC device to retrieve operating system installer information, and subsequently copies portions of the operating system installer information from the BMC memory subsystem to a host memory subsystem using an MMBI. The host processing subsystem then uses the operating system installer information in the host memory subsystem to provide an operating system installer subsystem that, during the initialization operations, instructs the BMC device to retrieve operating system image information, subsequently copies portions of the operating system image information from the BMC memory subsystem to the host memory subsystem using the MMBI, and installs an operating system using the operating system image information in the host memory subsystem. As discussed below, the failure of operating system deployments due to low/limited management network connectivity and/or fluctuating management network bandwidth is eliminated using the teachings of the present disclosure, with the MMBI operating system deployment systems and methods described herein allowing relatively large data transfers in low network connectivity/high network bandwidth fluctuation environments due to its independence from transport layer media timeout limitations.

The method 300 begins at block 302 where a BIOS subsystem provided by a host processing subsystem instructs a BMC device to retrieve a portion of operating system installer information. In some embodiments of block 302, the computing device 200 may be provided in the networked system and connected to the management network 210 as described above with reference to FIG. 2. The computing device 200 may then be powered on, booted, reset, rebooted, and/or otherwise initialized such that the computing device begins initialization. In some examples, the initialization described below may provide for a “first boot” of the computing device 200 that occurs immediately subsequent to its manufacture and in which an operating system must be deployed on the computing device 200 in order to configure the computing device to operate in a desired manner, although embodiments in which the initialization described below is performed on each boot of the computing device 200 will fall within the scope of the present disclosure as well.

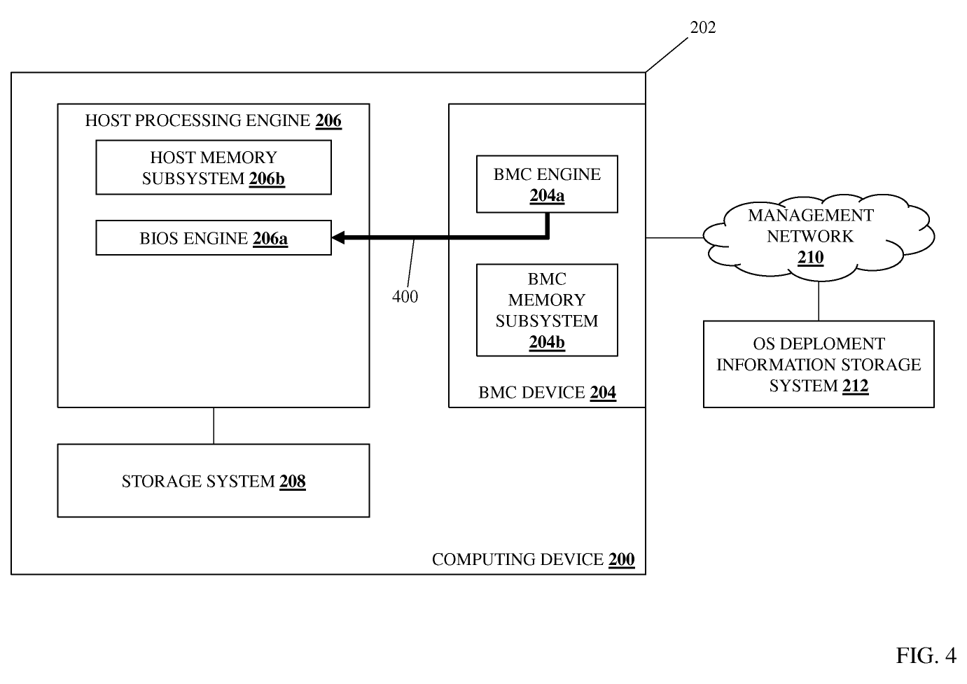

With reference to FIG. 4, as part of the initialization of the computing device 200, the BMC device 204 may initialize such that the BMC engine 204a is available, and the host processing engine 206 may provide the BIOS engine 206a in order to provide the BIOS described above that is configured to perform hardware initialization, the MMBI operating system deployment functionality described below, and/or other BIOS initialization operations that would be apparent to one of skill in the art in possession of the present disclosure. As part of the initialization of the computing device 200, the BMC engine 204a may perform boot option presentation operations 400 that include presenting boot options to the BIOS engine 206a that include an “MMBI boot” option to boot via the MMBI provided between the host processing engine 206 and the BMC device 204.

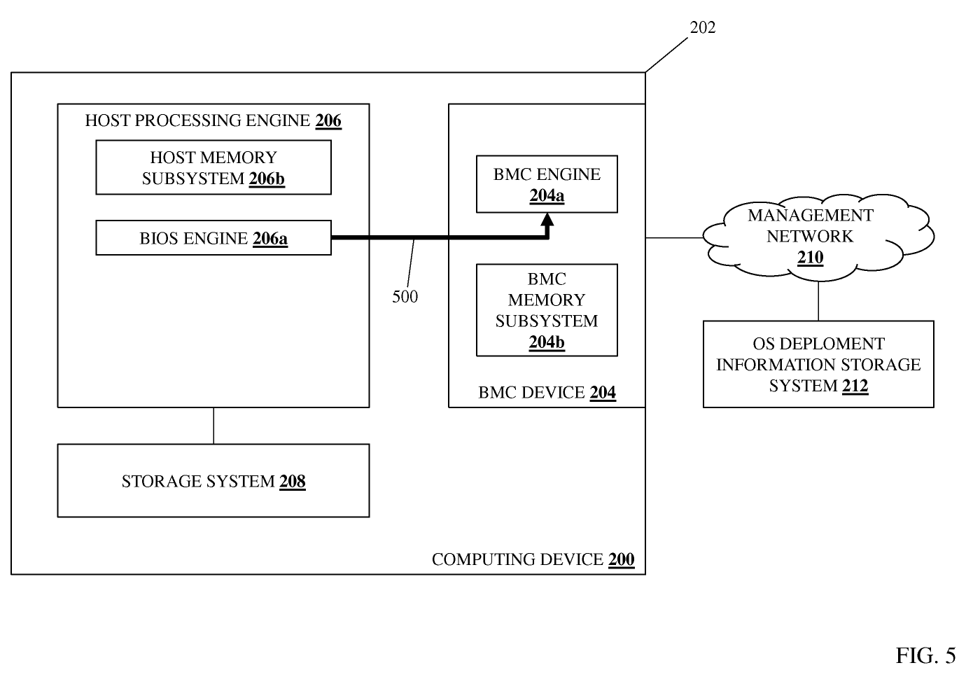

With reference to FIG. 5, in response to being presented with the MMBI boot option, the BIOS engine 206a may perform boot option selection operations 500 that include selecting the MMBI boot option presented by the BMC engine 204a. The BIOS engine 206a may then instruct the BMC engine 204a to retrieve a portion of operating system installer information that, as discussed below, enables the operating system deployment discussed below via the MMBI between the host processing engine 206 and the BMC device 204. As will be appreciated by one of skill in the art in possession of the present disclosure, the host processing engine 206/BIOS engine 206a may be configured to default to selecting the MMBI boot option, may be instructed by a user to select the MMBI boot option, and/or may select the MMBI boot option using any other boot option selection techniques known in the art. As discussed below, the method 300 may loop such that the BIOS engine 204a provides a plurality of instructions to the BMC engine 204a throughout the method 300 to retrieve each portion of the operating system installer information as they are needed by the BIOS engine 204a.

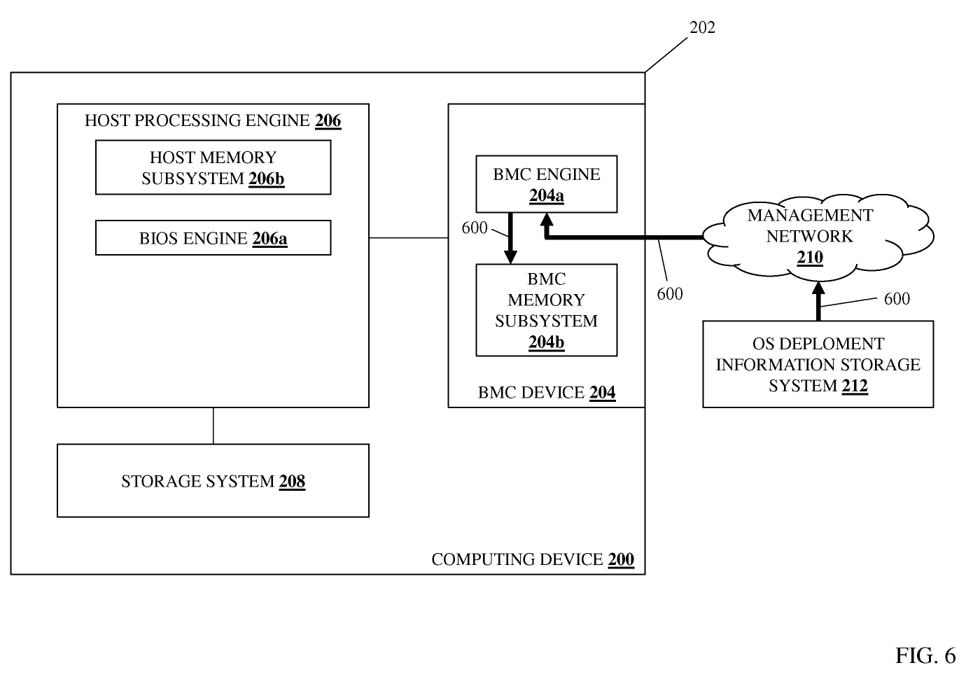

The method 300 then proceeds to block 304 where the BMC device retrieves the portion of the operating system installer information via a management network and stores it in a BMC memory subsystem. With reference to FIG. 6, in an embodiment of block 304 and in response to being instructed to retrieve a portion of the operating system installer information by the BIOS engine 206a at block 302, the BMC engine 204a may perform operating system installer information retrieval operations 600 that include retrieving, via the management network 210, that portion of the operating system installer information that is stored in the operating system deployment information storage system 212, and storing that portion of the operating system installer information in the BMC memory subsystem 204b.

For example, at block 304 the BMC engine 204a may write a data packet that includes the portion of the operating system installer information to the BMC memory subsystem 204b, and one of skill in the art in possession of the present disclosure will appreciate how that data packet may include any of a variety of metadata and/or other information in addition to the operating system installer information described herein. Furthermore, one of skill in the art in possession of the present disclosure will appreciate how the BMC engine 204a may utilize locks, flags, or other memory subsystem use indicators in the BMC memory subsystem 204b when providing the portion of the operating system installer information therein to ensure that the BMC engine 204a and the BIOS engine 206a do not access the same location in the BMC memory subsystem 204b simultaneously or in any other manner that could result in data corruption.

As discussed above, the BMC memory subsystem 204b that is configured for use by the BMC engine 204a with the MMBI provided between the host processing engine 206 and the BMC device 204 may have a limited storage capacity, and thus one of skill in the art in possession of the present disclosure will appreciate how the portion of the operating system installer information retrieved and stored in the BMC memory subsystem 204b at block 304 may be any size that is less than that storage capacity. As such, in some examples the operating system installer information stored in the operating system deployment information storage system 212 may have previously been “broken up” into portions that are each smaller in size than the storage capacity of the BMC memory subsystem 204b, while in other examples the BMC engine 204a may be configured to only retrieve portions of the operating system installer information that are smaller in size than the storage capacity of the BMC memory subsystem 204b. Furthermore, while a few specific examples are provided, one of skill in the art in possession of the present disclosure will appreciate how the portioned operating system installer information retrieval described herein may be performed using other techniques that will fall within the scope of the present disclosure as well.

The method 300 then proceeds to block 306 where the BMC device provides an interrupt associated with the availability of the portion of the operating system installer information to the BIOS subsystem. In an embodiment, at block 306 and following the retrieval of the portion of the operating system installer information, the BMC engine 204a in the BMC device 204 may perform interrupt provisioning operations 700 that include generating an interrupt that is provided to the BIOS engine 206a and that is configured to indicate that a portion of the operating system installer information is available in the BMC memory subsystem 204b via the MMBI, and one of skill in the art in possession of the present disclosure will appreciate how the interrupt provided by the BMC engine 204a to the BIOS engine 206a at block 306 may include any of a variety of MMBI memory subsystem information availability indications known in the art.

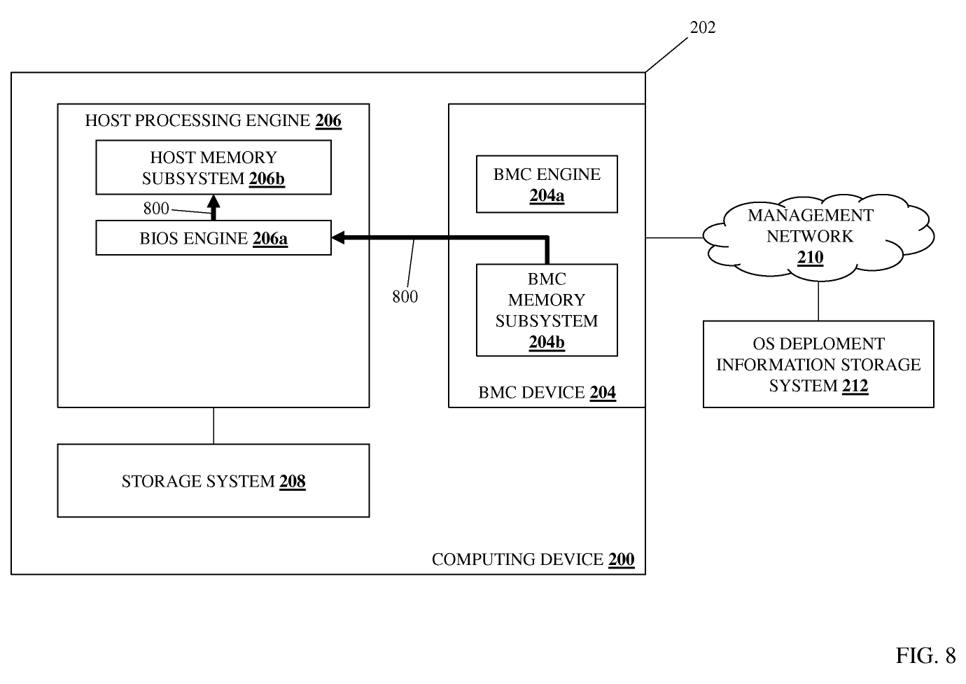

The method 300 then proceeds to block 308 where the BIOS subsystem copies the portion of the operating system installer information from the BMC memory subsystem to a host memory subsystem using an MMBI. With reference to FIG. 8, in an embodiment of block 308 and in response to receiving the interrupt, the BIOS engine 206a may perform operating system installer information portion retrieval operations 800 that include retrieving the portion of the operating system installer information via the MMBI and from the BMC memory subsystem 204b, and storing that portion of the operating system installer information in the host memory subsystem 206b.

For example, the BIOS engine 206a may read the data packet that was written by the BMC device 204a and that includes the portion of the operating system installer information from the BMC memory subsystem 204b, and write that portion of the operating system installer information to the host memory subsystem 206b. Similarly as described above, one of skill in the art in possession of the present disclosure will appreciate how the BIOS engine 206a may utilize locks, flags, or other memory subsystem use indicators in the BMC memory subsystem 204b when retrieving the portion of the operating system installer information stored therein to ensure that the BIOS engine 206a and the BMC engine 204a do not access the same location in the BMC memory subsystem 204b simultaneously or in any other manner that could result in data corruption.

As will be appreciated by one of skill in the art in possession of the present disclosure, the use of the MMBI by the BIOS engine 206a to copy the portion of the operating system installer information from the BMC memory subsystem 204b to the host memory subsystem 206b at block 308 is not subject to a timeout operation subsequent to the BIOS engine 206a instructing the BMC device 204 to retrieve the operating system installer information, thus eliminating the operating system deployment failures that occur in conventional operating system deployment systems discussed above due to the timeout operations used with USB requests and responses.

The method 300 then proceeds to decision block 310 where the method 300 proceeds depending on whether all portions of the operating system installer information have been provided. In an embodiment, at decision block 310, the BMC engine 204a in the BMC device 204 may determine whether all of the portions of the operating system installer information have been provided to the BIOS engine 206a, and one of skill in the art in possession of the present disclosure will appreciate how the BMC engine 204a may perform decision block 310 based on whether further instructions to retrieve portions of the operating system installer information are received from the BIOS engine 206a (similarly as described above with reference to block 302), based on the tracking of the provisioning of each portion of the operating system installer information from the operating system deployment storage system 212 to the BIOS engine 206a (i.e., to determine when all portions of the operating system installer information have been provided from the operating system deployment storage system 212 to the BIOS engine 206a), and/or using any of a variety of techniques that will fall within the scope of the present disclosure.

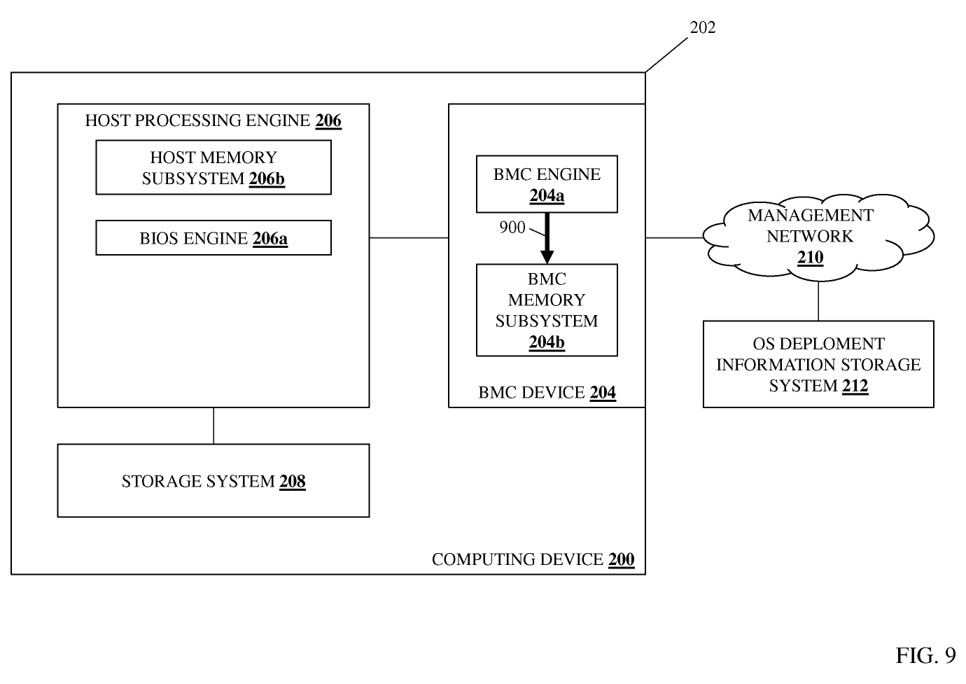

If, at decision block 310, all portions of the operating system installer information have not been provided, the method 300 may then proceed to optional block 312 where the BMC device may erase a portion of the operating system installer information from the BIOS memory subsystem. With reference to FIG. 9, in an embodiment of optional block 310 and following a request for a portion of the operating system installer information from the BIOS engine 206a that may indicate that all portions of the operating system installer information have not been provided at decision block 310, the BMC engine 204a in the BMC device 204 may perform operating system installer information portion erase operations 900 that include erasing a portion of the operating system installer information from the BMC memory subsystem 204b that was previously provided in the BMC memory subsystem 204b during a previous performance of block 304.

In a specific example, the BMC engine 204a in the BMC device 204 may be configured to store three different portions of the operating system installer information in the BMC memory subsystem 204b, and to erase the oldest portion of the operating system installer information from the BMC memory subsystem 204b when a portion of the operating system installer information is requested by the BIOS engine 206a that is not included in the three different portions of the operating system installer information that are currently stored in the BMC memory subsystem 204b. As such, if a request is received from the BIOS engine 206a at decision block 310 for a portion of the operating system installer information that is included in the three different portions of the operating system installer information that are currently stored (e.g., “cached”) in the BMC memory subsystem 204b, optional block 312 may be skipped and the method 300 may return to block 304. However, if a request is received from the BIOS engine 206a at decision block 310 for a portion of the operating system installer information that is not included in the three different portions of the operating system installer information that are currently stored in the BMC memory subsystem 204b, optional block 312 may be performed before the method 300 returns to block 304.

As such, in an embodiment of optional block 312, the BIOS engine 206a may remove the lock, flag, or other memory subsystem use indicator that it provided for the BMC memory subsystem 204b as discussed above, which may indicate to the BMC engine 204a that the oldest portion of the operating system installer information that was stored in the BMC memory subsystem 204b by the BMC engine 204a at block 304 may be erased, and the BMC engine 204a may perform the operating system installer information portion erase operations 900 to erase the oldest portion of the operating system installer information from the BMC memory subsystem 204b so that the requested portion of the operating system installer information may be stored in the BMC memory subsystem during the subsequent performance of block 304. However, while a specific example has been provided, one of skill in the art in possession of the present disclosure will appreciate how the BMC engine 204a may determine that the portion of the operating system installer information may be erased from the BMC memory subsystem 204b, and may erase that portion of the operating system installer information from the BMC memory subsystem 204b, using a variety of techniques that will fall within the scope of the present disclosure as well.

As such, the method 300 may loop through blocks 304-312 such that, on each loop, the BMC engine 204a may retrieve and/or provide a requested portion of the operating system installer information to the BIOS engine 206a via the BMC memory subsystem 204b and MMBI, while occasionally erasing a portion of the operating system installer information from the BMC memory subsystem 204b (so that other portions of the operating system installer information may be provided to the BIOS engine 206a via the BMC memory subsystem 204b) until all of the portions of the operating system installer information have been provided to the BIOS engine 206a.

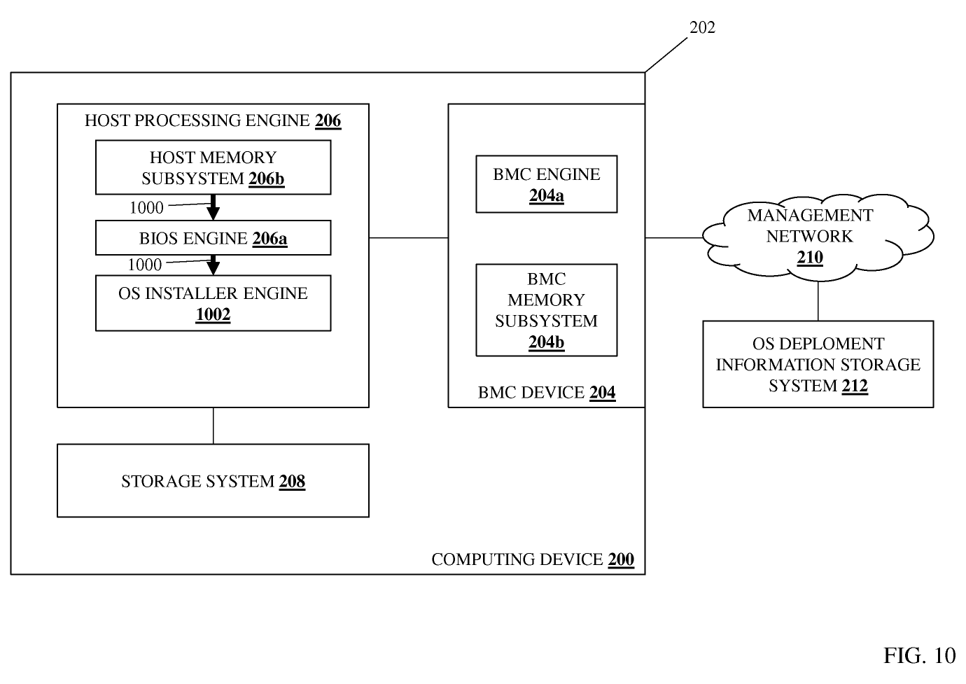

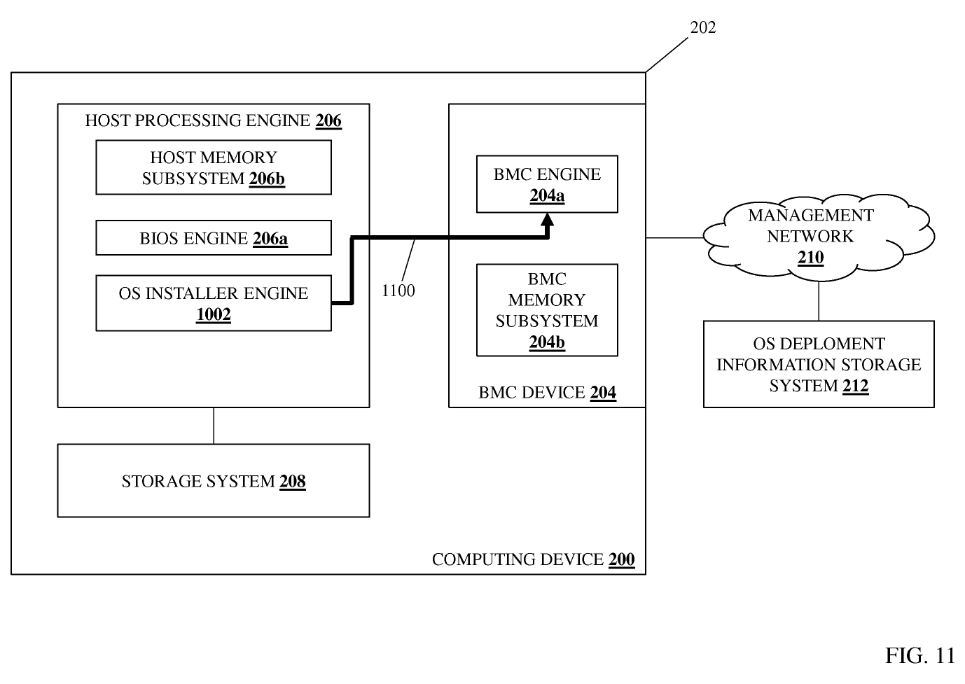

If, at decision block 310, all portions of the operating system installer information have been retrieved, the method 300 proceeds to block 314 where an operating system installer subsystem provided by the host processing subsystem instructs the BMC device to retrieve a portion of operating system image information. With reference to FIG. 10, as part of the initialization of the computing device 200, the BIOS engine 206a may perform operating system installer engine provisioning operations 1000 that include using the operating system installer information stored in the host memory subsystem 206b to provide an operating system installer engine 1002 that is configured to perform the functionality of the operating system installer engines, operating system installer subsystems, and/or computing devices discussed below. In a specific example, the operating system installer engine 1002 may include a host/operating system MMBI driver that configures the operating system installer engine 1002 to provide the MMBI functionality described below. With reference to FIG. 11, at block 314, the operating system installer engine 1002 may perform operating system image information retrieval instruction operations 1100 that include instructing the BMC engine 204a to retrieve a portion of operating system image information that, as discussed below, enables the operating system deployment discussed below via the MMBI between the host processing engine 206 and the BMC device 204. As discussed below, the method 300 may loop such that the operating system installer engine 1002 provides a plurality of instructions to the BMC engine 204a throughout the method 300 to retrieve each portion of the operating system image information as they are needed by the operating system installer engine 1002.

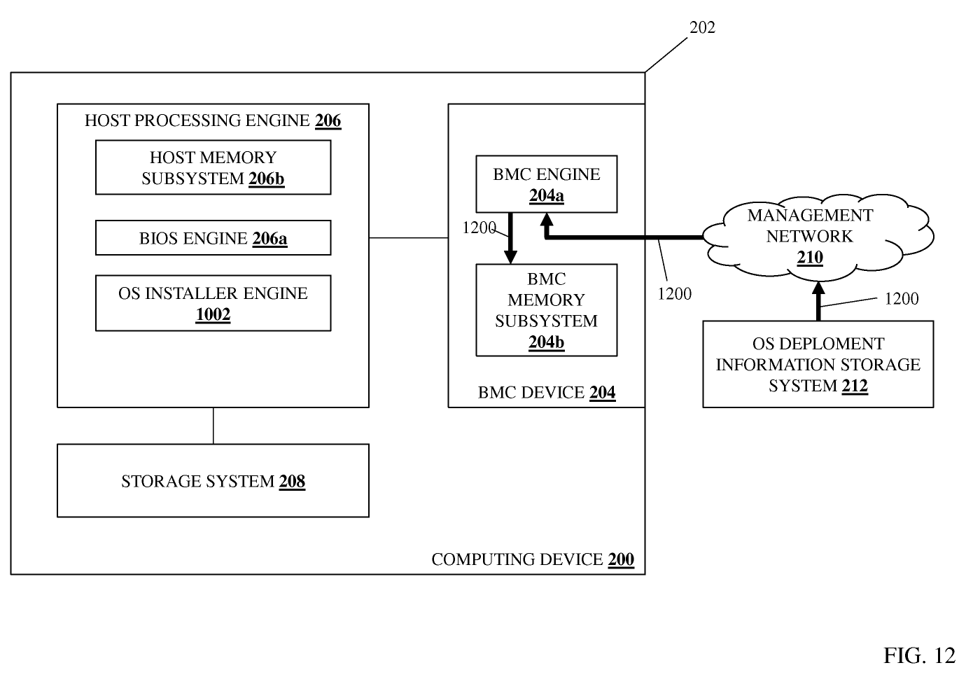

The method 300 then proceeds to block 316 where the BMC device retrieves a portion of the operating system image information via a management network and stores it in a BMC memory subsystem. With reference to FIG. 12, in an embodiment of block 316 and in response to being instructed to retrieve a portion of the operating system image information by the operating system installer engine 1002, the BMC engine 204a may perform operating system image information retrieval operations 1200 that include retrieving, via the management network 210, the portion of the operating system image information that is stored in the operating system deployment information storage system 212, and storing that portion of the operating system image information in the BMC memory subsystem 204b.

Similarly as described above, the BMC engine 204a may write a data packet that includes the portion of the operating system image information to the BMC memory subsystem 204b, and one of skill in the art in possession of the present disclosure will appreciate how that data packet may include any of a variety of metadata and/or other information in addition to the operating system image information described herein. Similarly as described above, one of skill in the art in possession of the present disclosure will appreciate how the BMC engine 204a may utilize locks, flags, or other memory subsystem use indicators in the BMC memory subsystem 204b when providing the portion of the operating system image information therein to ensure that the BMC engine 204a and the BIOS engine 206a do not access the same location in the BMC memory subsystem 204b simultaneously or in any other manner that could result in data corruption.

As discussed above, the BMC memory subsystem 204b that is configured for use by the BMC engine 204a with the MMBI provided between the host processing engine 206 and the BMC device 204 may have a limited storage capacity, and thus one of skill in the art in possession of the present disclosure will appreciate how the portion of the operating system image information retrieved and stored in the BMC memory subsystem at block 304 may be any size that is less than that storage capacity. As such, in some examples the operating system image information stored in the operating system deployment information storage system 212 may have previously been “broken up” into portions that are each smaller in size than the storage capacity of the BMC memory subsystem 204b, while in other examples the BMC engine 204a may be configured to only retrieve portions of the operating system image information that are smaller in size than the storage capacity of the BMC memory subsystem 204b. Furthermore, while a few specific examples are provided, one of skill in the art in possession of the present disclosure will appreciate how the portioned operating system image information retrieval described herein may be performed using other techniques that will fall within the scope of the present disclosure as well.

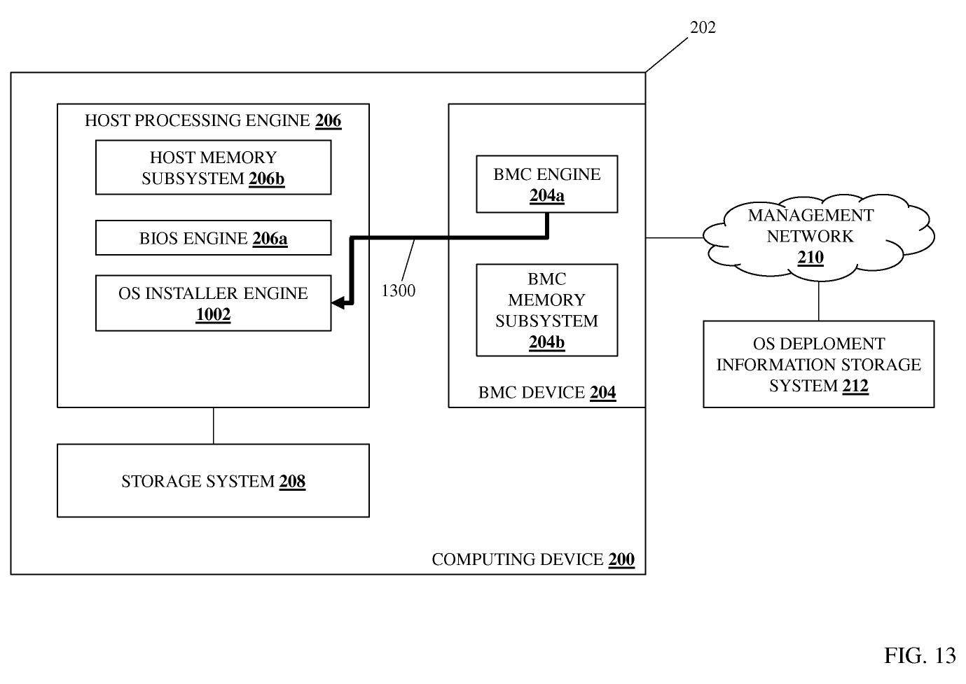

The method 300 then proceeds to block 318 where the BMC device provides an interrupt associated with the availability of the portion of the operating system image information to the operating system installer subsystem. With reference to FIG. 13, in an embodiment of block 318 and following the retrieval of the portion of the operating system image information, the BMC engine 204a in the BMC device 204 may perform interrupt provisioning operations 1300 that include generating an interrupt that is provided to the operating system installer engine 1002 and that is configured to indicate that a portion of the operating system image information is available in the BMC memory subsystem 204b via the MMBI, and one of skill in the art in possession of the present disclosure will appreciate how the interrupt provided by the BMC engine 204a to the operating system installer engine 1002 at block 306 may include any of a variety of MMBI memory subsystem information availability indications known in the art.

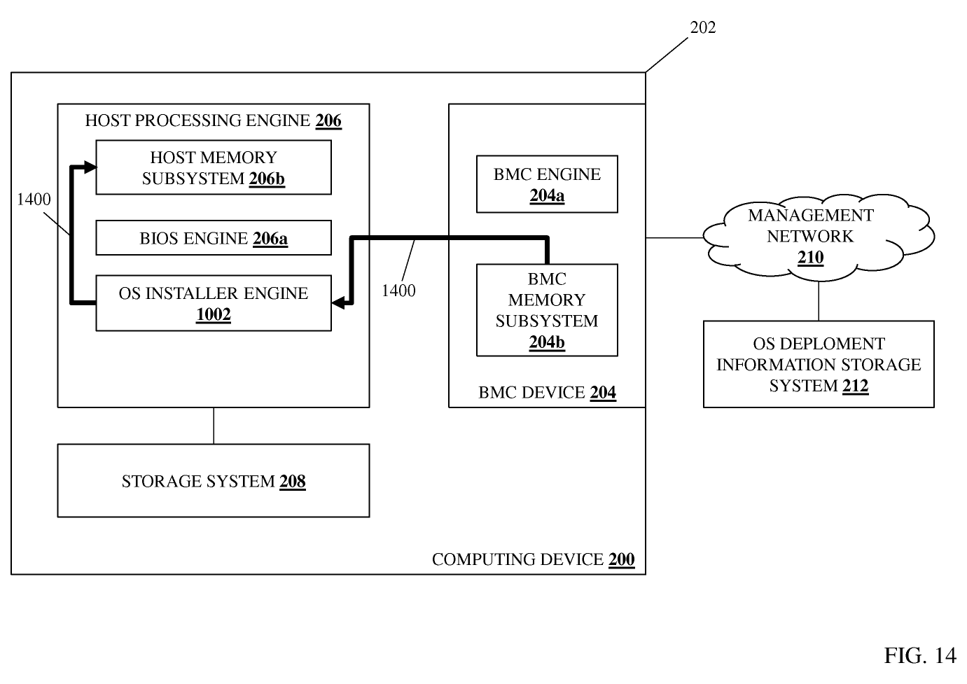

The method 300 then proceeds to block 320 where the operating system installer subsystem copies the portion of the operating system image information from the BMC memory subsystem to the host memory subsystem using the MMBI. With reference to FIG. 14, in an embodiment of block 320 and in response to receiving the interrupt, the operating system installer engine 1002 may perform operating system image information portion retrieval operations 1400 that include retrieving the portion of the operating system image information via the MMBI and from the BMC memory subsystem 204b, and storing that portion of the operating system image information in the host memory subsystem 206b.

For example, the operating system installer engine 1002 may read the data packet that was written by the BMC device 204a and that includes the portion of the operating system image information from the BMC memory subsystem 204b, and write that portion of the operating system image information to the host memory subsystem 206b. Similarly as described above, one of skill in the art in possession of the present disclosure will appreciate how the operating system installer engine 1002 may utilize locks, flags, or other memory subsystem use indicators in the BMC memory subsystem 204b when retrieving the portion of the operating system image information stored therein to ensure that the operating system installer engine 1002 and the BMC engine 204a do not access the same location in the BMC memory subsystem 204b simultaneously or in any other manner that could result in data corruption.

As will be appreciated by one of skill in the art in possession of the present disclosure, the use by the operating system installer engine 1002 of the MMBI to copy the portion of the operating system image information from the BMC memory subsystem 204b to the host memory subsystem 206b at block 320 is not subject to a timeout operation subsequent to the operating system installer engine 1002 instructing the BMC device 204 to retrieve the operating system image information, thus eliminating the operating system deployment failures that occur in conventional operating system deployment systems discussed above due to the timeout operations used with USB requests and responses.

The method 300 then proceeds to decision block 322 where the method 300 proceeds depending on whether all portions of the operating system image information have been provided. In an embodiment, at decision block 322, the BMC engine 204a in the BMC device 204 may determine whether all of the portions of the operating system image information have been provided to the operating system installer engine 1002, and one of skill in the art in possession of the present disclosure will appreciate how the BMC engine 204a may perform decision block 322 based on whether further instructions to retrieve portions of the operating system image information are received from the operating system installer engine 1002 (similarly as described above with reference to block 314), based on the tracking of the provisioning of each portion of the operating system image information from the operating system deployment storage system 212 to the operating system installer engine 1002 to determine when all portions of the operating system image information have been provided from the operating system deployment storage system 212 to the operating system installer engine 1002, and/or using any of a variety of techniques that will fall within the scope of the present disclosure.

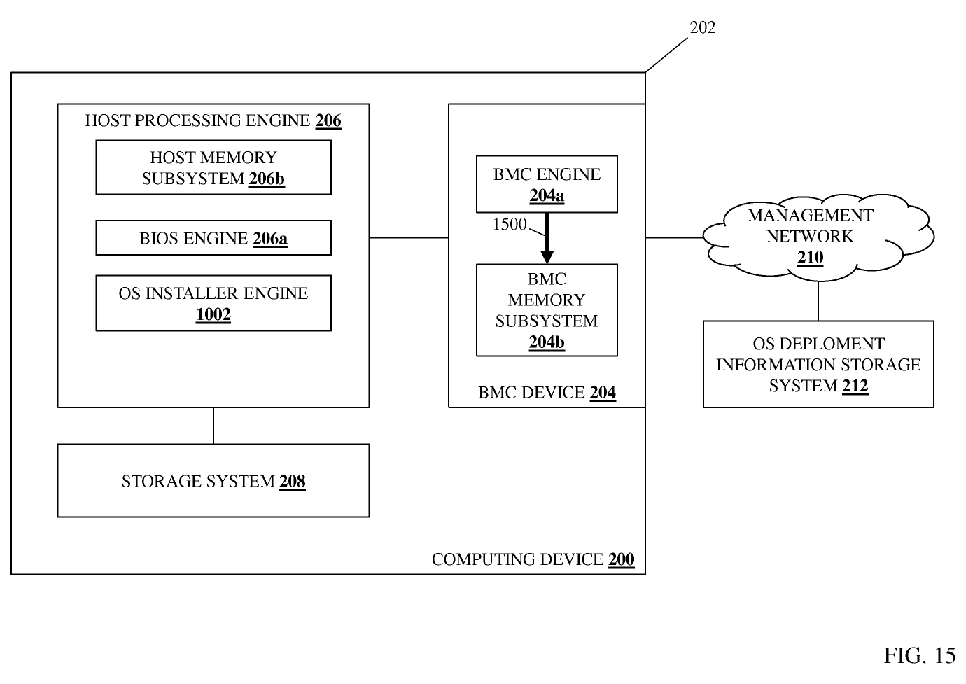

If, at decision block 322, all portions of the operating system image information have not been provided, the method 300 may proceed to optional block 324 where the BMC device may erase a portion of the operating system image information from the BIOS memory subsystem. With reference to FIG. 15, in an embodiment of optional block 322 and following a request for a portion of the operating system image information from the operating system installer engine 1002 that may indicate that all portions of the operating system installer information have not been provided at decision block 322, the BMC engine 204a in the BMC device 204 may perform operating system image information portion erase operations 1500 that include erasing a portion of the operating system image information from the BMC memory subsystem 204b that was previously provided in the BMC memory subsystem 204b during a previous performance of block 316.

In a specific example, the BMC engine 204a in the BMC device 204 may be configured to store three different portions of the operating system image information in the BMC memory subsystem 204b, and to erase the oldest portion of the operating system image information from the BMC memory subsystem 204b when a portion of the operating system image information is requested by the operating system installer engine 1002 that is not included in the three different portions of the operating system image information that are currently stored (e.g. “cached”) in the BMC memory subsystem 204b. As such, if a request is received from the operating system installer engine 1002 at block 322 for a portion of the operating system image information that is included in the three different portions of the operating system installer information that are currently stored in the BMC memory subsystem 204b, optional block 324 may be skipped and the method 300 may return to block 316. However, if a request is received from the operating system installer engine 1002 at decision block 322 for a portion of the operating system image information that is not included in the three different portions of the operating system image information that are currently stored in the BMC memory subsystem 204b, optional block 324 may be performed before the method 300 returns to block 316.

As such, in an embodiment of optional block 324, the operating system installer engine 1002 may remove the lock, flag, or other memory subsystem use indicator that it provided for the BMC memory subsystem 204b as discussed above, which may indicate to the BMC engine 204a that the oldest portion of the operating system image information that was stored in the BMC memory subsystem 204b by the BMC engine 204a at block 316 may be erased, and the BMC engine 204a may perform the operating system image information portion erase operations 1500 to erase the oldest portion of the operating system image information from the BMC memory subsystem 204b so that the requested portion of the operating system image information may be stored in the BMC memory subsystem during the subsequent performance of block 316. However, while a specific example has been provided, one of skill in the art in possession of the present disclosure will appreciate how the BMC engine 204a may determine that the portion of the operating system image information may be erased from the BMC memory subsystem 204b, and may erase that portion of the operating system image information from the BMC memory subsystem 204b, using a variety of techniques that will fall within the scope of the present disclosure as well

As such the method 300 may loop through blocks 316-324 such that, on each loop, the BMC engine 204a retrieves and provides a respective portion of the operating system image information to the operating system installer engine 1002 via the BMC memory subsystem 204b and MMBI, while occasionally erasing the oldest portion of the operating system image information from the BMC memory subsystem 204b so that other portions of the operating system image information may be provided to the operating system installer engine 1002 via the BMC memory subsystem 204b, until all of the portions of the operating system image information have been provided to the operating system installer engine 1002.

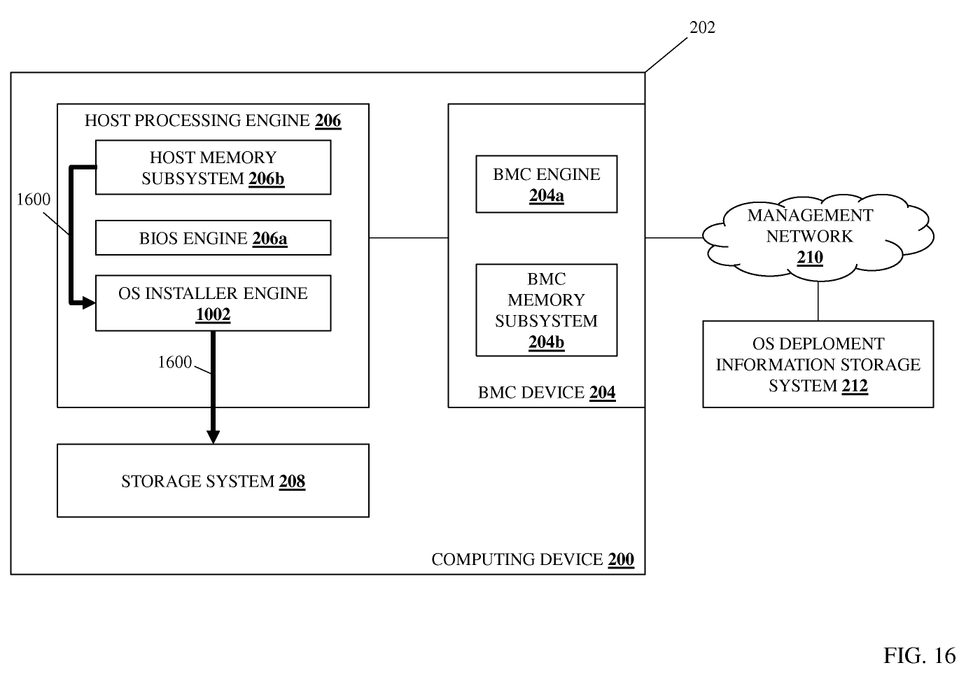

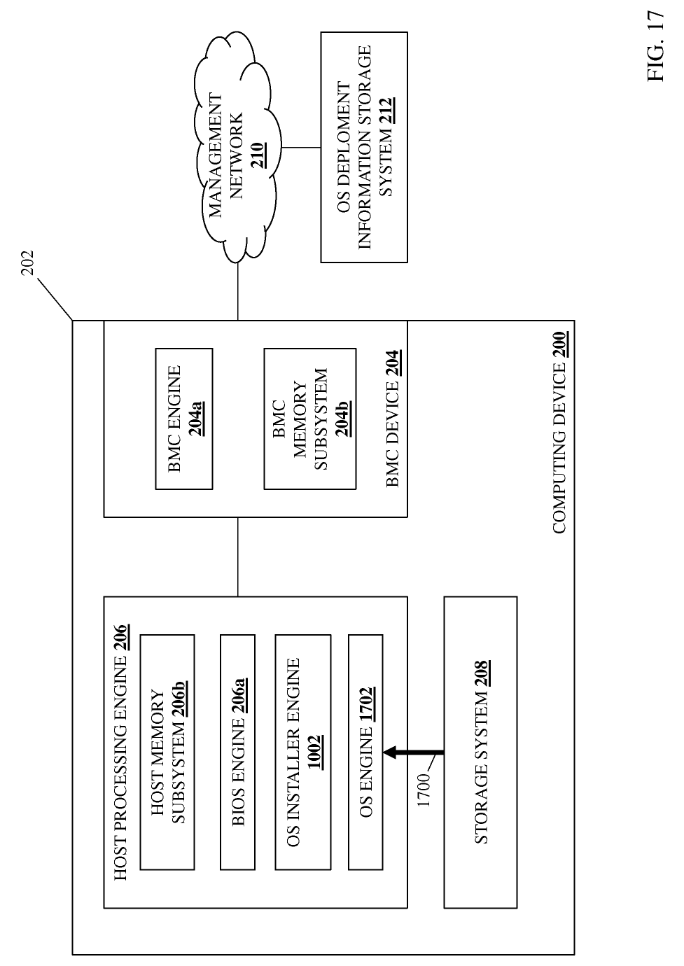

If, at decision block 322, all portions of the operating system image information have been provided, the method 300 proceeds to block 326 where the operating system installer subsystem installs an operating system using the operating system image information. With reference to FIGS. 16 and 17, in an embodiment of block 326, the operating system installer engine 1002 may perform operating system installation operations 1600 that include using the operating system image information stored in the host memory subsystem 206b to provide operating system engine instructions in the storage system 208, and the host processing engine 206 may then perform operating system provisioning operations 1700 that include using the operating system engine instructions stored in the storage system 208 to provide an operating system engine 1702 that is configured to provide an operating system for the computing device 200.

Thus, systems and methods have been described that provide for the deployment of operating system via a host processing subsystem using operating system deployment information retrieved from a BMC device via an MMBI. For example, the MMBI operating system deployment system of the present disclosure may include a chassis housing a BMC device that includes a BMC memory subsystem and that is coupled to a host processing subsystem. The host processing subsystem provides a BIOS subsystem that, during initialization operations, instructs the BMC device to retrieve operating system installer information, and subsequently copies portions of the operating system installer information from the BMC memory subsystem to a host memory subsystem using an MMBI. The host processing subsystem then uses the operating system installer information in the host memory subsystem to provide an operating system installer subsystem that, during the initialization operations, instructs the BMC device to retrieve operating system image information, subsequently copies portions of the operating system image information from the BMC memory subsystem to the host memory subsystem using the MMBI, and installs an operating system using the operating system image information in the host memory subsystem. As discussed below, the failure of operating system deployments due to low/limited management network connectivity and/or fluctuating management network bandwidth is eliminated using the teachings of the present disclosure, with the MMBI operating system deployment systems and methods described herein allowing relatively large data transfers in low network connectivity/high network bandwidth fluctuation environments due to its independence from transport layer media timeout limitations.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Memory Mapped Baseboard Management Controller (BMC) Interface (MMBI) operating system deployment system, comprising:
a chassis;
a Baseboard Management Controller (BMC) device that is housed in the chassis and that includes a BMC memory subsystem; and
a host processing subsystem that is housed in the chassis, coupled to the BMC device, and configured to provide a Basic Input/Output System (BIOS) subsystem that is configured, during initialization operations, to:
instruct the BMC device to retrieve operating system installer information; and
copy, to a host memory subsystem using a Memory Mapped BMC Interface (MMBI) subsequent to instructing the BMC device to retrieve the operating system installer information, a plurality of portions of the operating system installer information from the BMC memory subsystem, wherein the host processing subsystem is configured to use the operating system installer information that was copied to the host memory subsystem to provide an operating system installer subsystem that is configured, during the initialization operations, to:
instruct the BMC device to retrieve operating system image information;
copy, to the host memory subsystem using the MMBI subsequent to instructing the BMC device to retrieve the operating system image information, a plurality of portions of the operating system image information from the BMC memory subsystem; and
install, using the operating system image information that was copied to the host memory subsystem, an operating system.

2. The system of claim 1, wherein the BIOS subsystem copying each of the plurality of portions of the operating system installer information from the BMC memory subsystem to the host memory subsystem using the MMBI includes:
receiving, from the BMC device, an interrupt associated with the availability of that portion of the operating system installer information in the BMC memory subsystem; and
copying, in response to receiving the interrupt, that portion of the operating system installer information from the BMC memory subsystem to the host memory subsystem using the MMBI.

3. The system of claim 2, wherein the BMC device is configured, for each of the plurality of portions of the operating system installer information, to:
retrieve, via a management network from an operating system deployment information storage system, that portion of the operating system installer information;
store that portion of the operating system installer information in the BMC memory subsystem; and
erase that portion of the operating system installer information from the BMC memory subsystem subsequent to the BIOS subsystem copying of that portion of the operating system installer information from the BMC memory subsystem to the host memory subsystem using the MMBI.

4. The system of claim 1, wherein the operating system installer subsystem copying each of the plurality of portions of the operating system image information from the BMC memory subsystem to the host memory subsystem using the MMBI includes:
receiving, from the BMC device, an interrupt associated with the availability of that portion of the operating system image information in the BMC memory subsystem; and
copying, in response to receiving the interrupt, that portion of the operating system image information from the BMC memory subsystem to the host memory subsystem using the MMBI.

5. The system of claim 4, wherein the BMC device is configured, for each of the plurality of portions of the operating system image information, to:
retrieve, via a management network from an operating system deployment information storage system, that portion of the operating system image information;
store that portion of the operating system image information in the BMC memory subsystem; and
erase that portion of the operating system image information from the BMC memory subsystem subsequent to the operating system installer subsystem copying of that portion of the operating system image information from the BMC memory subsystem to the host memory subsystem using the MMBI.

6. The system of claim 1, wherein the copying of each of the plurality of portions of the operating system installer information from the BMC memory subsystem to the host memory subsystem using the MMBI is not subject to a timeout operation, and wherein the copying of each of the plurality of portions of the operating system image information from the BMC memory subsystem to the host memory subsystem using the MMBI is not subject to a timeout operation.

7. An Information Handling System (IHS), comprising:
a host processing system; and
a host memory system that is coupled to the host processing system and that includes instructions that, when executed by the host processing system, cause the host processing system to provide a host processing engine that is configured to provide a Basic Input/Output System (BIOS) engine that is configured, during initialization operations, to:
instruct a Baseboard Management Controller (BMC) device that is coupled to the host processing system to retrieve operating system installer information; and
copy, to a host memory subsystem using a Memory Mapped BMC Interface (MMBI) subsequent to instructing the BMC device to retrieve the operating system installer information, a plurality of portions of the operating system installer information from a BMC memory subsystem included in the BMC device, wherein the host engine is configured to use the operating system installer information that was copied to the host memory subsystem to provide an operating system installer engine that is configured, during the initialization operations, to:
instruct the BMC device to retrieve operating system image information;
copy, to the host memory subsystem using the MMBI subsequent to instructing the BMC device to retrieve the operating system image information, a plurality of portions of the operating system image information from the BMC memory subsystem; and
install, using the operating system image information that was copied to the host memory subsystem, an operating system.

8. The IHS of claim 7, wherein the BIOS engine copying each of the plurality of portions of the operating system installer information from the BMC memory subsystem to the host memory subsystem using the MMBI includes:
receiving, from the BMC device, an interrupt associated with the availability of that portion of the operating system installer information in the BMC memory subsystem; and
copying, in response to receiving the interrupt, that portion of the operating system installer information from the BMC memory subsystem to the host memory subsystem using the MMBI.

9. The IHS of claim 8, further comprising:
the BMC device including:
a BMC processing system; and
a BMC memory system that is coupled to the BMC processing system and that includes instructions that, when executed by the BMC processing system, cause the BMC processing system to provide a BMC engine that is configured, for each of the plurality of portions of the operating system installer information, to:
retrieve, via a management network from an operating system deployment information storage system, that portion of the operating system installer information;
store that portion of the operating system installer information in the BMC memory subsystem; and
erase that portion of the operating system installer information from the BMC memory subsystem subsequent to the BIOS engine copying of that portion of the operating system installer information from the BMC memory subsystem to the host memory subsystem using the MMBI.

10. The IHS of claim 7, wherein the operating system installer engine copying each of the plurality of portions of the operating system image information from the BMC memory subsystem to the host memory subsystem using the MMBI includes:
receiving, from the BMC device, an interrupt associated with the availability of that portion of the operating system image information in the BMC memory subsystem; and
copying, in response to receiving the interrupt, that portion of the operating system image information from the BMC memory subsystem to the host memory subsystem using the MMBI.

11. The IHS of claim 10, further comprising:
the BMC device including:
a BMC processing system; and
a BMC memory system that is coupled to the BMC processing system and that includes instructions that, when executed by the BMC processing system, cause the BMC processing system to provide a BMC engine that is configured, for each of the plurality of portions of the operating system image information, to:
retrieve, via a management network from an operating system deployment information storage system, that portion of the operating system image information;
store that portion of the operating system image information in the BMC memory subsystem; and
erase that portion of the operating system image information from the BMC memory subsystem subsequent to the operating system installer engine copying of that portion of the operating system image information from the BMC memory subsystem to the host memory subsystem using the MMBI.

12. The IHS of claim 7, wherein the copying of each of the plurality of portions of the operating system installer information from the BMC memory subsystem to the host memory subsystem using the MMBI is not subject to a timeout operation.

13. The IHS of claim 7, wherein the copying of each of the plurality of portions of the operating system image information from the BMC memory subsystem to the host memory subsystem using the MMBI is not subject to a timeout operation.

14. A method for deploying an operating system on a computing device using a Memory Mapped Baseboard Management Controller (BMC) Interface (MMBI), comprising:
instructing, by a BIOS subsystem provided by a host processing subsystem during initialization operations, a BMC device to retrieve operating system installer information;
copying, by the BIOS subsystem to a host memory subsystem using a Memory Mapped BMC Interface (MMBI) during the initialization operations and subsequent to instructing the BMC device to retrieve the operating system installer information, a plurality of portions of the operating system installer information from a BMC memory subsystem in the BMC device;
providing, by the host processing subsystem during the initialization operations using the operating system installer information that was copied to the host memory subsystem, an operating system installer subsystem;
instructing, by the operating system installer subsystem during the initialization operations, the BMC device to retrieve operating system image information;
copying, by the operating system installer subsystem to the host memory subsystem using the MMBI during the initialization operations and subsequent to instructing the BMC device to retrieve the operating system image information, a plurality of portions of the operating system image information from the BMC memory subsystem; and
installing, by the operating system installer subsystem using the operating system image information that was copied to the host memory subsystem, an operating system.

15. The method of claim 14, wherein the copying each of the plurality of portions of the operating system installer information from the BMC memory subsystem to the host memory subsystem using the MMBI includes:
receiving, by the BIOS subsystem from the BMC device during the initialization operations, an interrupt associated with the availability of that portion of the operating system installer information in the BMC memory subsystem; and
copying, by the BIOS subsystem during the initialization operations in response to receiving the interrupt, that portion of the operating system installer information from the BMC memory subsystem to the host memory subsystem using the MMBI.

16. The method of claim 15, further comprising, for each of the plurality of portions of the operating system installer information:
retrieving, by the BMC device via a management network from an operating system deployment information storage system, that portion of the operating system installer information;
storing, by the BMC device, that portion of the operating system installer information in the BMC memory subsystem; and
erasing, by the BMC device, that portion of the operating system installer information from the BMC memory subsystem subsequent to the BIOS subsystem copying of that portion of the operating system installer information from the BMC memory subsystem to the host memory subsystem using the MMBI.

17. The method of claim 14, wherein the copying each of the plurality of portions of the operating system image information from the BMC memory subsystem to the host memory subsystem using the MMBI includes:
receiving, by the operating system installer subsystem from the BMC device, an interrupt associated with the availability of that portion of the operating system image information in the BMC memory subsystem; and
copying, by the operating system installer subsystem in response to receiving the interrupt, that portion of the operating system image information from the BMC memory subsystem to the host memory subsystem using the MMBI.

18. The method of claim 14, further comprising, for each of the plurality of portions of the operating system image information:
retrieving, by the BMC device via a management network from an operating system deployment information storage system, that portion of the operating system image information;
storing, by the BMC device, that portion of the operating system image information in the BMC memory subsystem; and
erasing, by the BMC device, that portion of the operating system image information from the BMC memory subsystem subsequent to the operating system installer subsystem copying of that portion of the operating system image information from the BMC memory subsystem to the host memory subsystem using the MMBI.

19. The method of claim 14, wherein the copying of each of the plurality of portions of the operating system installer information from the BMC memory subsystem to the host memory subsystem using the MMBI is not subject to a timeout operation.

20. The method of claim 14, wherein the copying of each of the plurality of portions of the operating system image information from the BMC memory subsystem to the host memory subsystem using the MMBI is not subject to a timeout operation.
